(19) United States
(12) Patent Application Publication
(10) Pub. No.: US 2013/0108750 A1
(43) Pub. Date: May 2, 2013

(54) Barbeque Grill Having an Angled Cooking Surface

(71) Applicant: Santiago Vitagliano, Miami Beach, FL (US)

(72) Inventor: Santiago Vitagliano, Miami Beach, FL (US)

(21) Appl. No.: 13/282,373

(22) Filed: Oct. 26, 2011

(51) Int. Cl. A47J 37/06; A23L 1/325; A23L 1/31; A23L 1/315; A23L 1/015; A23L 1/01

(52) U.S. Cl. 426/312; 99/425; 426/478; 426/479; 426/480

(57) ABSTRACT

A cooking device, having a cooking surface made of a solid corrugated panel that is positioned at a non-horizontal angle such that fats and greases drain first into natural troughs in the panel and then down into a drainage trough running along a lower front edge of the cooking surface.

### TECHNICAL FIELD

The present invention relates to grills and barbeque cooking equipment.

### BACKGROUND OF THE INVENTION

Barbequing meats and fish over charcoal has been done for centuries. However, there are many common problems that still remain with today's barbeque systems. For example, fats and greases tend to simply pool near the food when cooked on a flat cooking surface. It is not desirable to have these excess fats and greases simply cooked into the foods. Instead, it would be preferable to have the fats and greases drain away from the food. Therefore, most barbeque style cooking is done on an open grill made of parallel metal bars. Unfortunately, problems remain with having the fats and greases from the meat or fish simply drop back through the grill into the charcoal pit below. For example, excessive smoke is produced and carcinogens from the boiling fat or grease simply waft back up into the food. Additionally the fats and greases tend to burn and fire flares generate excessive heat which tends to prematurely burn the food. As a result, barbequing tends to be a smoky affair. Therefore, it must either be done outdoors (with good neighbors) or indoors (with a very good fan and ventilation system). Another problem with fats and greases dripping through the open grill is that this system of drainage is really quite inferior. Fats and greases simply fall back down into the charcoal pit under the grill. They are not picked up and removed during the cooking process. Often, they are not removed at, all making grilling dangerous given that unclean grills with substantial grease deposits catch fire and are not easily extinguishable. Or, when they are removed, it is only after they have hardened onto the grill and into the charcoal pit below the grill. Cleaning today's barbeque grills and stoves is a messy, tedious and time consuming task.

It would instead be desirable to provide a barbeque system that quickly and easily removes excess fats and greases from the cooking area during food preparation, and also minimizes the affects of smoke both in terms of making the smoke cleaner and in terms of directing it away from the food. In would also be desirable to have the cooking area as free as possible from smoke such that it is easy to see the food while barbequing it. The present invention provides these advantages as explained below.

### SUMMARY OF THE INVENTION

The present invention provides a cooking device having a cooking surface made of a solid corrugated panel. This solid corrugated panel is positioned at a non-horizontal angle such that excess fats and greases drain first into the troughs in the panel and then down into a drainage trough running along a lower front edge of the cooking surface.

In preferred aspects, the present invention provides a cooking device, comprising: a frame; a cooking surface supported by the frame (wherein the cooking surface is a solid corrugated panel), and wherein the cooking surface is positioned at a non-horizontal angle by the frame; and a drainage trough positioned adjacent to a lower end of the cooking surface.

The cooking surface is positioned at a non-horizontal angle for two important reasons. First, it causes cooking grease and fat to drain down the cooking surface and into the drainage trough. Second, it causes smoke from below the cooking surface to be directed towards the upper (back) end of the cooking surface. Thus, excess fats and greases are continuously removed at the front of the cooking panel while excess smoke is continuously removed (for example by fan and vent) at the back of the cooking panel. A charcoal pit, gas burning element or electric heating element is positioned under the cooking surface, and may be held in position by the same frame that may hold the cooking surface and drainage trough.

The present invention also provides a method of cooking, comprising: placing food on a solid corrugated cooking surface that is positioned at a non-horizontal angle; cooking the food by applying heat to the bottom of the solid corrugated cooking surface; and draining cooking grease and fat off the lower end of the corrugated cooking surface.

A first advantage of the present system is that fats and greases are continuously removed during cooking. A second advantage of the present system is that smoke is directed away from the food and is collected at the back of the device (where it can optionally be funneled up into a chimney or let free through openings at the back of the corrugated cooking surface). A third advantage of the present system is that smoke is reduced since fats and greases melt and drain away from the grill at temperatures that are lower than their burning temperatures. A fourth advantage of the present system is that fire flares are reduced simply by draining away the excess fats and greases. As a result, the food is less likely to burn. A fifth advantage is reduced cancer producing fumes since the grease will not evaporate and be burned by the fire (which generally infuses the food protein with toxic substances). Sixth, reducing the fats and greases in the food results in a healthier protein source. Seventh, overall cleaning is much easier since it is not necessary to change refractory bricks, grill surfaces, electric heating elements or stones since the fats and grease do not accumulate on them. All of the above results in a longer grill life.

### BRIEF DESCRIPTION OF THE DRAWINGS

FIG. 1 is an assembled perspective view of the present invention.

FIG. 2 is an exploded perspective view of the present invention.

FIG. 3 is an exploded front elevation view of the present invention.

FIG. 4 is a top plan view of the present invention.

FIG. 5 is an exploded side elevation view of the present invention.

FIG. 6A is a sectional front elevation view of a first embodiment of the present invention taken through line 6-6- in FIG. 4.

FIG. 6B is a sectional front elevation view of a second embodiment of the present invention taken through line 6-6- in FIG. 4.

### DETAILED DESCRIPTION OF THE DRAWINGS

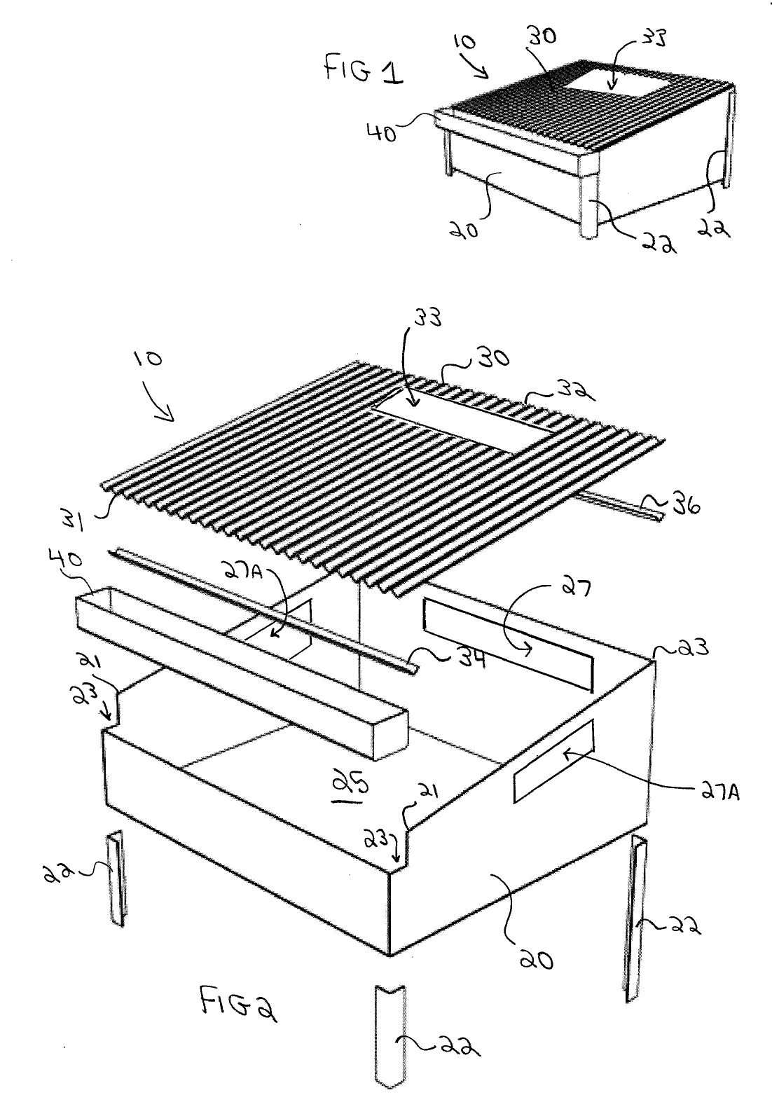

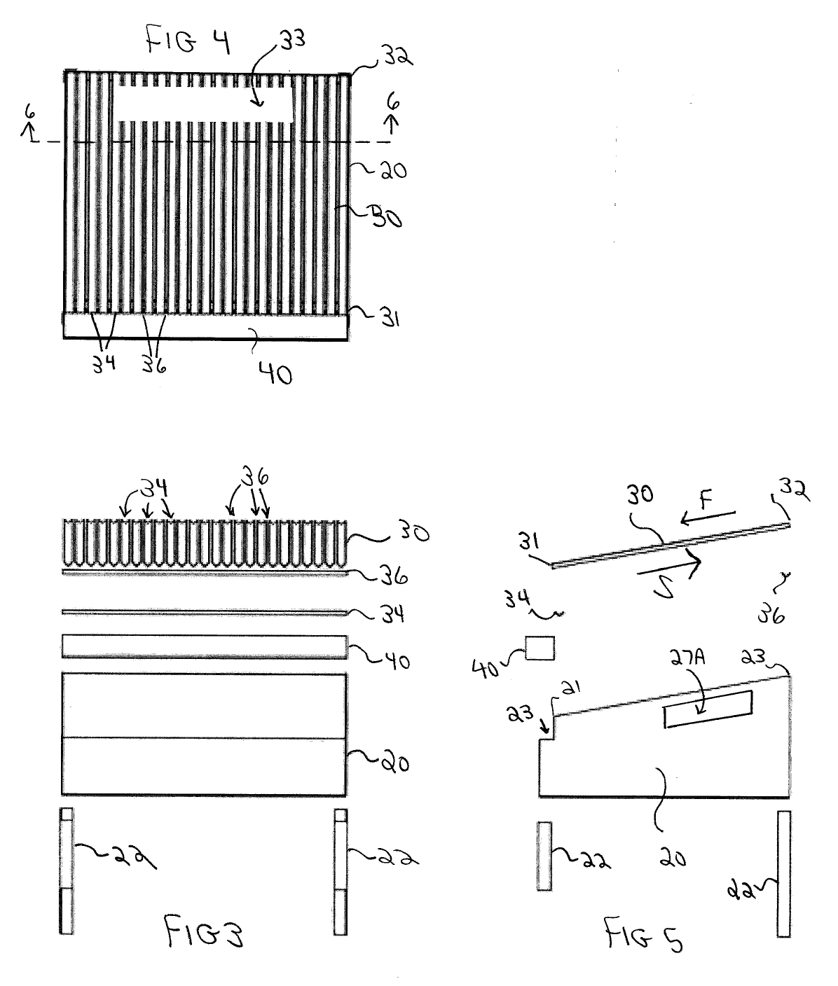

As seen in FIGS. 1 to 5, the present invention provides a barbeque grilling cooking device 10. Device 10 comprises: a frame 20; a cooking surface 30 and a drainage trough 40. Cooking surface 30 is supported by frame 20 such that it is held at a non-horizontal angle to the ground, as shown. Most preferably, cooking surface 30 is positioned at an angle of between 5 and 25 degrees to the ground. It is to be understood, however, that the present invention is not limited by any particular angle. All that is important is that the angle of cooking surface 30 to the horizontal is sufficiently large to drain fats and greases on the top of cooking surface 30 towards the lower front end 31, and to direct smoke towards the upper back end 32 of the grill which may exit the grill by either rear window 27 or side windows 27A or by optional window 33 in corrugated surface 30. In addition, the angle has to of course be sufficiently small so that the food itself does not slide off the front 31 of the grill during cooking. In optional aspects of the invention, the angle may itself be adjustable such that different foods can be cooked at different angles.

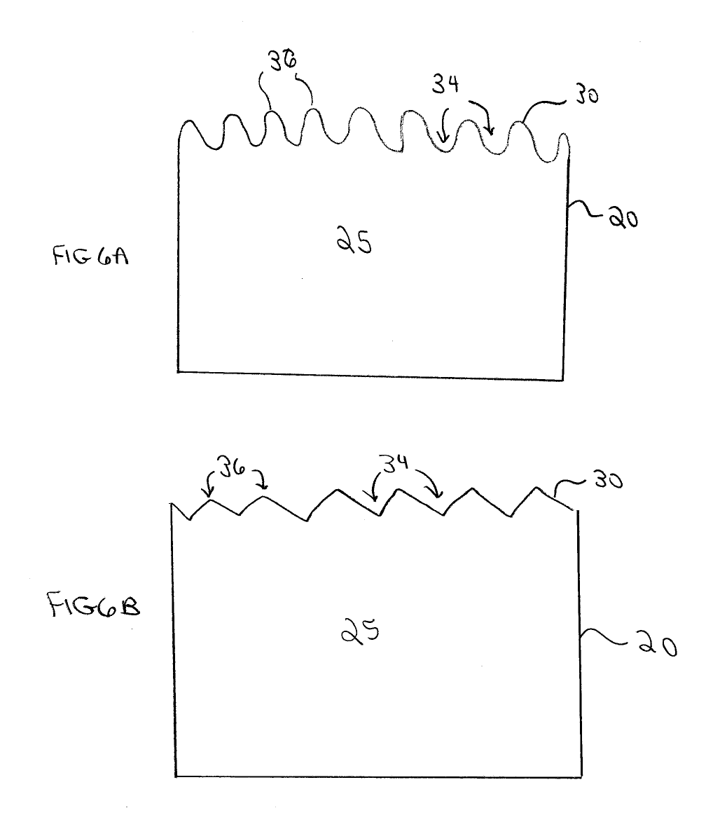

Drainage trough 40 is positioned adjacent to lower end 31 of cooking surface 30 as shown. During cooking, excess fats and greases will first pool within the natural troughs 34 in corrugated cooking surface 30 before draining down into trough 40. The food itself will be supported underneath by the natural crests 36 in corrugated cooking surface 30. This novel design has the advantage of quickly removing the excess fats and greases from the food cooking area. As seen in FIG. 5, the fats and greases will drain down cooking surface 30 in direction F toward lower front end 31. At the same time, smoke from underneath the grill with be directed in direction S towards upper back end 32.

Many designs of frame 20 are possible, and the present invention is not limited to any particular shape or design. In the illustrated version, frame 20 simply comprises an elevated box-like structure supported by four legs 22. Frame 20 has an internal section 25 in which charcoal or electric heating elements may be placed. As seen in FIG. 5, frame 20 may have a lower front 21 and a higher back 23. A pair of notches 23 may be provided at the front to support drainage trough 40. In optional embodiments, one notch 23 may be higher than the other such that drainage trough 40 is also held at an angle to the floor. This would cause the excess fats and greases to drain towards one end of drainage trough 40 for collection.

Preferably a window 27 is provided at the back of frame 20 or in the case of retrofitting existing grill systems a window or combinations thereof 27A or 33, to permit smoke (from internal cooking section 25) to pass out of. When cooking indoors, window 27 is preferably positioned below a vent or chimney (not shown) or at the back or side areas of the cooking surface 30 as in 27A and 33.

The present invention encompasses many designs for frame 20 to support corrugated cooking surface 30. In the illustrated embodiments, supports 34 and 36 span across the bottom of cooking surface 30 and are connected at their ends to the sides of frame 20, as shown. Most preferably, supports 34 and 36 may be welded onto the bottom of corrugated cooking surface 30. It is to be understood that supports 34 and 36 may be releasable attached to frame 20 such that corrugated cooking surface 30 could be removed for cleaning and to place more charcoal in internal cooking section 25. The corrugated cooking surface 30 may also have 2 or more removable sections to allow the feeding of charcoal or additional ventilation in the case of a conventional fire grill.

In preferred embodiments, corrugated cooking surface 30 is made of steel, covered by a non stick surface material such as Teflon or alike. It is to be understood, however, that any particular material does not limit the present invention and several combinations will produce different heat exchange ratios.

FIG. 6A shows an embodiment of corrugated panel 30 having a repeating V-shaped cross sectional structure. FIG. 6B shows an embodiment of corrugated panel 30 having a repeating U-shaped cross sectional structure.

The present invention also provides a method of cooking, by: placing food on solid corrugated cooking surface 30 that is positioned at a non-horizontal angle; cooking the food by applying heat to the bottom of the solid corrugated cooking surface (i.e.: by heating with charcoal or heating elements in internal section 25); and draining cooking grease and fat (in direction F) off lower end 31 of corrugated cooking surface 30. The preferred method further comprises directing smoke under cooking surface 30 (in direction S) to upper end 31 of cooking surface 30. The preferred method further comprises passing such smoke out of internal section 25 through window 27 and up into a vent or chimney.

In preferred options, the food cooked is meat, poultry, pork or fish, and cooking the food comprises heating corrugated panel 30 by burning charcoal in a charcoal pit 25 under cooking surface 30. Draining cooking grease and fat off lower end 31 of corrugated cooking surface 30 comprises collecting the grease and fat in drainage trough 40. Prior to the grease and fat draining into trough 40 it preferably pools into troughs 34 in corrugated panel 30.

What is claimed is:

1. A cooking device, comprising:
a frame;
a cooking surface supported by the frame, wherein the cooking surface is a solid corrugated panel, and wherein the cooking surface is positioned at a non-horizontal angle by the frame; and
a drainage trough positioned adjacent to a lower end of the cooking surface.

2. The cooking device of claim 1, wherein the corrugated panel has a repeating V-shaped cross sectional structure.

3. The cooking device of claim 1, wherein the corrugated panel has a repeating U-shaped cross sectional structure.

4. The cooking device of claim 1, wherein cooking grease and fat pool into troughs in the corrugated panel.

5. The cooking device of claim 1, wherein the cooking surface is positioned at the non-horizontal angle to cause cooking grease and fat to drain down the cooking surface and into the drainage trough.

6. The cooking device of claim 1, wherein the cooking surface is positioned at the non-horizontal angle to cause smoke from below the cooking surface to be directed towards the upper end of the cooking surface.

7. The cooking device of claim 1, wherein the cooking surface is made of steel, covered by a non stick surface material

8. The cooking device of claim 1, wherein troughs in the corrugated panel are perpendicular to the drainage trough.

9. The cooking device of claim 1, further comprising:
a vent positioned over the cooking surface or to a side of the cooking surface, wherein the vest is configured to receive smoke passing up from under the cooking surface at an upper end of the cooking surface.

10. The cooking device of claim 1, further comprising:
a charcoal pit positioned under the cooking surface, wherein the charcoal pit is supported by the frame.

11. A method of cooking, comprising:
placing food on a solid corrugated cooking surface that is positioned at a non-horizontal angle;
cooking the food by applying heat to the bottom of the solid corrugated cooking surface; and
draining cooking grease and fat off the lower end of the corrugated cooking surface.

12. The method of claim 11, further comprising:
directing smoke under the cooking surface to the upper end of the cooking surface.

13. The method of claim 12, further comprising:
sending the smoke up a vent.

14. The method of claim 11, wherein draining cooking grease and fat off the lower end of the corrugated cooking surface comprises:
collecting the grease and fat in a drainage trough positioned adjacent to a lower end of the corrugated cooking surface.

15. The method of claim 14, further comprising:
pooling the grease and fat into troughs in the corrugated panel and then draining the grease and fat from the troughs in the corrugated panel into the drainage trough positioned adjacent to a lower end of the corrugated cooking surface.

16. The method of claim 11, wherein cooking the food comprises heating the corrugated panel by burning charcoal in a charcoal pit, gas burning element or electric heating element under the cooking surface.

17. The method of claim 11, wherein the food is meat.

18. The method of claim 11, wherein the food is poultry.

19. The method of claim 11, wherein the food is fish.

20. The method of claim 11, wherein the food is pork.
